(19) United States
(12) Patent Application Publication
(10) Pub. No.: US 2004/0105066 A1
(43) Pub. Date: Jun. 3, 2004

(54) Liquid crystal display panel and method of manufacturing the same

(75) Inventor: Hideaki Tsuda, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 10/706,366

(22) Filed: Nov. 12, 2003

(30) Foreign Application Priority Data
Nov. 28, 2002 (JP) 2002-345543

(51) Int. Cl. C09K 19/02

(52) U.S. Cl. 349/177

(57) ABSTRACT

A liquid crystal showing a nematic phase at an ordinary temperature and having a negative dielectric anisotropy is filled between a TFT substrate and an opposing substrate, on which an alignment film is not formed. For example, acrylate monomer is added previously into the liquid crystal as an alignment control agent. The alignment control agent added into the liquid crystal is adhered onto surfaces of the TFT substrate and the opposing substrate and is grown thereon. Then, when the ultraviolet ray is irradiated, the alignment control agent is polymerized and then an alignment regulate layer is formed on surfaces of the TFT substrate and the opposing substrate respectively.

### CROSS-REFERENCE TO RELATED APLICATIONS

This application is based upon and claims priority of Japanese Patent Application No. 2002-345543, filed on Nov. 28, 2002, the contents being incorporated herein by reference.

### BACKGROUND OF THE INVENTION

1. Field of the Invention

The present invention relates to a vertical alignment type liquid crystal display device in which a liquid crystal into which an alignment control agent is mixed is filled between a pair of substrates and then an alignment regulate layer is formed by causing the alignment control agent to adhere onto surfaces of the substrates, and a method of manufacturing the same.

2. Description of the Prior Art

The liquid crystal display panel has such merits that the display panel is thin and lightweight and is driven by a low voltage to lower power consumption. Thus, the liquid crystal display panel is employed widely in various electronic devices.

The ordinary liquid crystal display panel employed in the television and the personal computer has such a structure that the liquid crystal is sealed between two sheets of transparent substrates arranged to oppose to each other. The picture element electrode and the TFT (Thin Film Transistor) are formed every subpixel on one substrate, while the color filters that oppose to the picture element electrodes and the common electrode that is common to respective subpixels are formed on the other substrate. Also, the polarizing plate is pasted onto the opposing surface and the opposite side surface of the transparent substrates respectively.

In the liquid crystal display device constructed in this manner, when a voltage is applied between the picture element electrode and the common electrode, a direction of molecules of the liquid crystal between the picture element electrode and the common electrode is changed. As a result, a transmittance of light of the liquid crystal is changed. Thus, the desired image can be displayed on the liquid crystal display panel by controlling the transmittance of light every subpixel. In the following, the substrate on which the picture element electrodes and the TFTs are formed is called the TFT substrate, and the substrate that is arranged to oppose to the TFT substrate is called the opposing substrate.

Normally, an interval (cell gap) between the TFT substrate and the opposing substrate is maintained constant by bead-like spherical spacers made of resin, ceramic, or the like. These bead-like spacers are scattered on any one substrate out of the TFT substrate and the opposing substrate when the TFT substrate and the opposing substrate are bonded by the sealing agent.

However, according to the method of scattering the bead-like spacers on the substrate, the spacers are not always uniformly distributed over the entire surface of the substrate. If the spacers are not uniformly distributed over the overall substrate, in-plane variation of the cell gap is generated to cause a reduction in display quality. Also, the molecules of the liquid crystal has such a property that they align along surfaces of the spacers. Therefore, if the bead-like spacer is present in the subpixel region, the alignment abnormality is generated and thus the display quality is lowered.

For this reason, in Patent Application Publication (KOKAI) Hei 9-73093 (Patent Literature 1), it was proposed that column-like spacers are formed between the subpixels (for example, at intersection portions between the data bus line and the gate. bus line) by using the photoresist. Also, in Patent Application Publication (KOKAI) Hei 11-160716 (Patent Literature 2), it was proposed that the alignment treatment is applied to the surfaces of the bead-like spacers.

Meanwhile, normally the alignment film to which the alignment treatment is applied is formed on. the surface of the TFT substrate and the surface of the opposing substrate. When no electric field is applied, an alignment direction of the molecules of the liquid crystal is decided by this alignment film. The rubbing treatment, i.e., a surface of the alignment film is rubbed in one direction by the roller round which a cloth such as Nylon, or the like is wound, is normal as the alignment treatment.

As the method of manufacturing the liquid crystal display panel that does not need the rubbing treatment, the polymer-stabilizing alignment method is known. In this method, the liquid crystal that is mixed with the monomers is filled between a pair of substrates. Then, the monomers are polymerized by irradiating the ultraviolet ray in a situation that the molecules of the liquid crystal are aligned by applying the voltage between electrodes. Thus, polymer networks are formed in the liquid crystal. The direction of the initial alignment of the molecules of the liquid crystal is decided by the polymer networks.

Also, in Patent Application Publication (KOKAI) 2000-321562 (Patent Literature 3), it was set forth that the silane coupling agent, the photopolymeric monomer, and the photopolymerization initiator are mixed into the liquid crystal having a negative dielectric anisotropy, then the liquid crystal is filled between a pair of substrates from a predetermined direction at a predetermined temperature to cause molecules of the raw material to align in a predetermined direction, and then the photopolymeric monomer is polymerized by irradiating the ultraviolet ray onto the liquid crystal, whereby the polymer networks are formed.

[Patent Literature 1 ]

Patent Application Publication (KOKAI) Hei 9-73093

[Patent Literature 2 ]

Patent Application Publication (KOKAI) Hei 11-160716

[Patent Literature 3 ]

Patent Application Publication (KOKAI) 2000-321562

As described above, in the prior art, the alignment film is formed on surfaces of the TFT substrate and the opposing substrate. In the polymer-stabilizing alignment method or the method set forth in Patent Application Publication (KOKAI) 2000-321562, the alignment treatment is not needed but the alignment film is needed.

In contrast, the applicant of this application has proposed the method of manufacturing the liquid crystal display panel that does not include the step of forming the alignment film (Patent Application No. 2002-160062, etc.). According to this method, the polymer networks are not formed in the liquid crystal, but a layer having an alignment regulation power (alignment regulation layer) is formed on the surface of the substrate. For example, when the liquid crystal into which the bifunctional acrylate monomer and the photopolymerization initiator are mixed is sealed between a pair of substrates, the acrylate monomer is adhered onto the surface of the substrate (the surface of the ITO film or the insulating film) and is grown thereon. Then, when the ultraviolet ray is irradiated, the monomer is polymerized and also chemically bonded to the surface of the substrate, so that the stable alignment regulation layer is formed. This alignment regulation layer has a regulation power for aligning the molecules of the liquid crystal in the growth direction of the monomer, i.e., the direction that is perpendicular to the substrate surface.

However, when the polarization plate is arranged on and under the liquid crystal display panel, that is manufactured by the above method, in the crossed nicols fashion and then such display panel is observed, essentially the overall display panel must be blackend, nevertheless in some case a broken line that glistens white in the panel is observed. In the following, the broken line that glistens white in this manner is called a “white line”. A length and a thickness of such white line are not constant, and thus the display quality is lowered conspicuously because of generation of such. white line.

### SUMMARY OF THE INVENTION

Therefore, it is an object of the present invention to provide a liquid crystal display panel that does not need formation of an alignment film, and is capable of suppressing generation of a white line and also getting excellent display quality, and a method of manufacturing the same.

The above subject can be overcome by providing a liquid crystal display panel in which a liquid crystal into which an alignment control agent is added is filled between a pair of substrates and an alignment regulate layer is formed on liquid crystal side surfaces of the pair of substrates respectively, wherein the liquid crystal shows a nematic phase at an ordinary temperature and a dielectric anisotropy of the liquid crystal is negative.

The above subject can be overcome by providing a method of manufacturing a liquid crystal display panel, which comprises the steps of preparing the liquid crystal that shows a nematic phase at an ordinary temperature and has a negative dielectric anisotropy; adding an alignment control agent into the liquid crystal; filling the liquid crystal, into which the alignment control agent is added, between a pair of substrates at least one of which is transparent; and forming an alignment regulate layer by causing the alignment control agent to adhere onto liquid crystal side surfaces of the pair of substrates respectively.

The above subject can be overcome by providing a liquid crystal display panel in which a liquid crystal into which an alignment control agent is added is filled between a pair of substrates and an alignment regulate layer is formed on liquid crystal side surfaces of the pair of substrates respectively, wherein column-like spacers for maintaining an interval between the pair of substrates constant are arranged in areas between subpixels.

The above subject can be overcome by providing a method of manufacturing a liquid crystal display panel, which comprises the steps of forming column-like spacers in areas between subpixels on at least one of a pair of substrates by exposing and developing a photoresist; preparing the liquid crystal into which an alignment control agent is added; arranging the pair of substrates to put the column-like spacers therebetween, and filling the liquid crystal into which the alignment control agent is added between the pair of substrates; and forming an alignment regulate layer by causing the alignment control agent to adhere onto liquid crystal side surfaces of the pair of substrates respectively.

In order to prevent the defects due to the white line in the liquid crystal display device in which the alignment regulate layer is formed by the alignment control agent that is added into the liquid crystal, the inventors of this application made various examinations and studies. As a result, it was found that, if the liquid crystal whose dielectric anisotropy Δε is about −3, for example, is employed, generation of the white line is remarkably reduced. Also, it was found that the white line is often generated from the spacer as a starting point. It was found that reduction in the display quality due to the white line can be avoided by controlling appropriately positions of the spacers.

As a result, in the invention of this application, as described above, the liquid crystal showing the nematic phase at an ordinary temperature and having the negative dielectric anisotropy is employed. Also, in the other invention of this application, the column-like spacers are formed in the areas that are no relevance to the display between the subpixels by using the photoresist, for example. Accordingly, it is possible to avoid reduction in the display quality due to the white line.

### BRIEF DESCRIPTION OF THE DRAWINGS

FIG. 1 is a schematic view showing generation of a black dot;

FIG. 2 is a schematic view showing generation of a white line;

FIG. 3 is a plan view showing one subpixel of a liquid crystal display panel according to a first embodiment of the present invention;

FIG. 4 is a sectional view taken along a I-I line in FIG. 3 ;

FIG. 5 is a table showing examined results of physical properties of the liquid crystal and a vertical alignment property of the liquid crystal;

FIG. 6 is a graph showing relationships between a diameter and a scattering density of bead-like spacers and a contrast ratio at 0 V and 5 V;

FIG. 7 is a schematic plan view showing positions of column-like spacers in a liquid crystal display panel according to a second embodiment of the present invention; and

FIG. 8 is a plan view showing column-like spacers arranged at intersection portions between gate bus lines and data bus lines.

### DETAILED DESCRIPTION OF THE PREFERRED EMBODIMENTS

The present invention will be explained in detail hereinafter.

According to the result obtained when the inventors of this application observed in detail the liquid crystal display panel in which the white line is generated, it is found that a black circular spot is present in a portion at which the white line is bent. This black spot is referred to as a “black dot” hereinafter. A size and a shape of the black dot are not constant. The black dot is attended with a line whose outer periphery glistens white. Then, the white line exists to connect the black dot and the black dot. Also, the black dot that is not attended with the white line and is present solely was observed.

The above white line and black dot are observed in the liquid crystal display panel that is put between a pair of polarization plates arranged in the crossed nicols fashion. But defective portions can also be observed by the microscope observation not using the polarization of light. In this case, the white line is observed as a line that is different from the normal portion, and the black dot is observed as a circular dot. Here, when the black dot is observed in the state that the polarization plate is not provided, such black dot can be observed easily.

When a voltage that is larger than a threshold voltage is applied to the liquid crystal display panel, the molecules of the liquid crystal around the white line and the black dot are aligned in the direction perpendicular to the electric field, and thus the white line disappears. However, when the voltage applied between the electrodes is turned OFF, sometimes the white line still disappears and sometimes the white line returns to its original state, or the white line connected to the different black dot newly appears. In contrast, a shape of the black dot is not changed irrespective of application of the voltage. Based on the above, it may be considered that the black dot is the deposit generated when the alignment control agent being mixed into the liquid crystal is solidified locally and separated (referred to as an “abnormal deposit” hereinafter), and that the white line is generated because the molecules of the liquid crystal are aligned between the abnormal deposits.

Accordingly, if the molecules of the liquid crystal can be aligned in the direction perpendicular to the substrate surface when the voltage is turned OFF, generation of the white line can be prevented in spite of the presence of the abnormal deposit and thus the display quality can be improved.

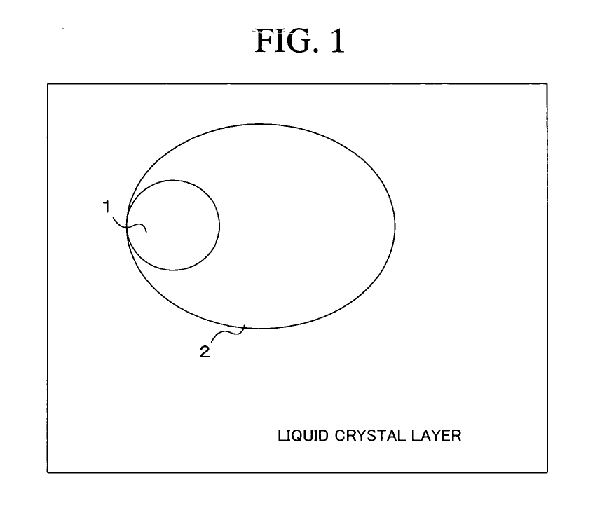

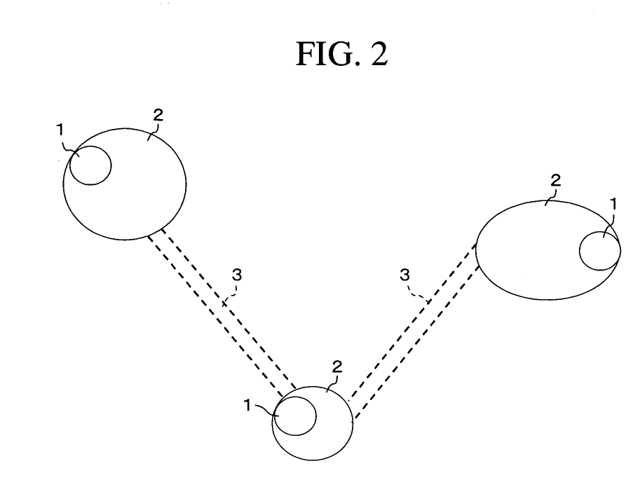

Also, as the result of the observation of the liquid crystal display panel in which the white line and the black dot are generated, the spacer for maintaining the interval between the substrates constant is often present in the black dot. That is, as shown in FIG. 1, it may be considered that, since the alignment control agent is separated round a spacer 1 as the nucleus mainly, a black dot 2 formed of the abnormal deposit is generated. Also, as shown in FIG. 2 , a white line 3 is generated to connect the black dots 2 generated in this manner. Therefore, if the spacers are formed in regions between the subpixels, which are not concerned with the display quality, the black dot and the white line are mainly generated in the regions between the subpixels and therefore reduction in the display quality can be avoided.

(First Embodiment)

A first embodiment of the present invention will be explained with reference to the accompanying drawings hereinafter. In this case, in the present embodiment, the generation of the white line is prevented irrespective of the presence of the black dot, by aligning the molecules of the liquid crystal perpendicularly to the substrate surface when the voltage applied between a pair of electrodes is turned OFF.

(Liquid Crystal Display Panel)

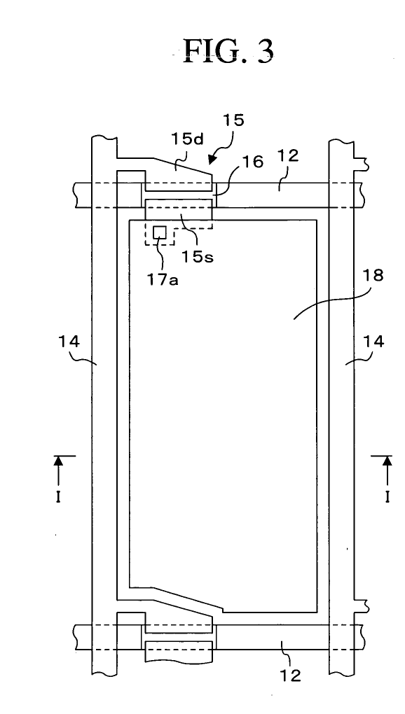

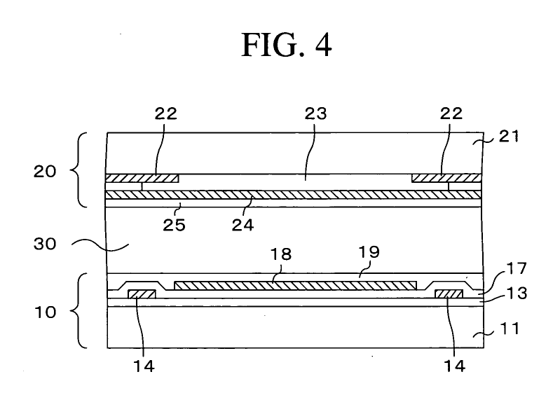

FIG. 3 is a plan view showing one subpixel of a liquid crystal display panel according to a first embodiment of the present invention. FIG. 4 is a sectional view taken along a I-I line in FIG. 3. Here, in the present embodiment, an example in which the present invention is applied to the transmissive liquid crystal display panel will be explained.

As shown in FIG. 4 , a liquid crystal display panel of the present embodiment comprises a TFT substrate 10 and an opposing substrate 20 both being arranged to oppose to each other, and nematic liquid crystal 30 sealed between the TFT substrate 10 and the opposing substrate 20 and having the negative dielectric anisotropy. In this case, a polarization plate is arranged under the TFT substrate 10 and on the opposing substrate 20 respectively. Also, a light source (back light) is arranged below the TFT substrate 10.

As shown in FIG. 3 and FIG. 4 , the TFT substrate 10 is constructed by a glass substrate 11, and gate bus lines 12, data bus lines 14, TFTs 15, picture element electrodes 18, etc. formed on the glass substrate 11. The gate bus lines 12 are extended in the horizontal direction, and the data bus lines 14 are extended in the vertical direction. A gate insulating film 13 is formed between the gate bus lines 12 and the data bus lines 14. The gate bus lines 12 and the data bus lines 14 are electrically isolated mutually by the gate insulating film 13. Areas that are defined by the gate bus lines 12 and the data bus lines 14 are subpixel areas respectively. An insulating film 17 is formed on the data bus lines 14 and the TFTs 15. The picture element electrodes 18 are formed on the insulating film 17. The picture element electrodes 18 and the TFTs 15 are formed in respective subpixel areas on one-by-one basis.

In the present embodiment, as shown in FIG. 3 , a part of the gate bus line 12 is formed as a gate electrode of the TFT 15. A source electrode 15s and a drain electrode 15d of the TFT 15 are arranged on both sides of a channel protection film 16 in the width direction respectively. The source electrode 15s is connected electrically to the picture element electrode 18 via a contact hole 17a formed in the insulating film 17 , and the drain electrode 15d is connected electrically to the data bus line 14. Also, an alignment regulation layer 19 is formed on the picture element electrode 18.

In contrast, the opposing substrate 20 is constructed by a glass substrate 21, and a black matrix 22, an insulating film 23, and a common electrode 24 formed on one surface side (lower side in FIG. 4 ) of the glass substrate 21. The black matrix 22 is formed to cover regions between the subpixels and TFT forming regions. Also, the insulating film 23 is formed on the lower side of the glass substrate 21 to cover the black matrix 22. The common electrode 24 is formed under the insulating film 23, and an alignment regulation layer 25 is formed under the common electrode 24.

Also, spacers (not shown) used to maintain constant an interval between the TFT substrate 10 and the opposing substrate 20 are arranged between the TFT substrate 10 and the opposing substrate 20.

The TFT substrate 10 and the opposing substrate 20 are arranged such that their surfaces on the picture element electrodes 18 and the common electrode 24 are formed respectively are opposed to each other, and are bonded by a sealing agent (not shown) coated on the outside of the display regions.

In the liquid crystal display panel constructed in this manner, when the image is to be displayed, a scanning signal is supplied sequentially from a driving circuit (not shown) to the gate bus lines 12 aligned in the vertical direction and also a display signal is supplied to the data bus lines 14. The TFT 15 connected to the gate bus line 12 to which the scanning signal is supplied is brought into its ON state, and the display signal is written into the picture element electrode 18 via the TFT 15. Accordingly, the electric field is generated between the picture element electrode 18 and the common electrode 24 in response to the display signal, and then the direction of the molecules of the liquid crystal is changed. As a result, a quantity of the light that transmitted through the subpixel is changed. The desired image can be displayed on the liquid crystal display panel by controlling a quantity of light of the transmitted light every subpixel.

In this case, the MVA (Multi-domain Vertical Alignment) type liquid crystal display device, in which a plurality of domains in which the alignment direction of the molecules of the liquid crystal are different respectively are provide in one subpixel by forming domain regulating projections (banks) on the electrodes 18, 24 or forming domain regulating slits in the electrodes 18, 24 , may be employed. According to this, the viewing angle characteristic can be improved remarkably.

(Method of Manufacturing the Liquid Crystal Display Panel)

A method of manufacturing the liquid crystal display panel according to the embodiment of the present invention will be explained hereunder.

First, the TFT substrate 10 and the opposing substrate 20 shown in FIG. 3 and FIG. 4 are manufactured respectively. In this case, since the alignment regulation layers 19, 25 are formed after the liquid crystal is sealed, the TFT substrate 10 may be formed up to the picture element electrodes 18 and also the opposing substrate 20 may be formed up to the common electrode 24.

Then, a method of manufacturing the TFT substrate 10 will be explained simply hereunder. First, a first metal film is formed on the glass substrate 11 by the PVD (Physical Vapor Deposition) method. Then, the gate bus lines 12 are formed by patterning the first metal film by means of the photolithography method. Then, the gate insulating film 13 is formed on the overall upper surface of the glass substrate 11, and a first silicon film acting as an operating layer of the TFTs 15 and an SiN film acting as the channel protection film 16 are formed thereon. Then, the channel protection films 16 are formed in predetermined areas over the gate bus lines 12 by patterning the SiN film by means of the photolithography method.

Then, a second silicon film into which an impurity is introduced at a high concentration is formed as an ohmic contact layer on the overall upper surface of the glass substrate 11. Then, a second metal film is formed on the second silicon film. Then, the second metal film, the second silicon film, and the first silicon film are patterned by the photolithography method. Thus, a shape of the silicon film acting as the operating layer of the TFTs 15 is defined and also the data bus lines 14, the source electrodes 15s, and the drain electrodes 15d are formed.

Then, the insulating film 17 is formed on the overall upper surface of the glass substrate 11, and then the contact holes 17 a are formed at predetermined positions on the insulating film 17. Then, a film made of transparent conductor such as ITO (Indium-Tin Oxide), or the like is formed on the overall upper surface of the glass substrate 11 . Then, the picture element electrodes 18, each of which is connected electrically to the source electrode 15s of the TFT 15 via the contact hole 17a, are formed by patterning the transparent conductive film. In this manner, the TFT substrate 10 is completed.

Then, a method of manufacturing the opposing substrate 20 will be explained simply hereunder. First, a metal film made of Cr, or the like is formed on the glass substrate 21. Then, the black matrix 22 is formed by patterning the metal film. Then, the insulating film 23 is formed on the glass substrate 21. In case the color liquid crystal display panel is manufactured, the insulating film 23 is formed of red (R), green (G), and blue (B) resins and then the insulating film 23 having any one color out of the red color, the green color and the blue color is arranged every subpixel.

Then, the common electrode 24 made of the transparent conductor such as ITO, or the like is formed on the insulating film 23. In this manner, the opposing substrate 20 is completed.

Then, the liquid crystal 30 is filled between the TFT substrate 10 and the opposing substrate 20 by the vacuum filling method or the drop filling method. When the liquid crystal 30 is filled between the substrates 10, 20 by the vacuum filling method, the sealing agent is coated on any one of (or both of) the TFT substrate 10 and the opposing substrate 20 to surround the display regions. Here, the sealing agent is not coated on the portion serving as the liquid crystal filling port. Then, the bead-like spacers are scattered on any one of the TFT substrate 10 and the opposing substrate 20, then the TFT substrate 10 and the opposing substrate 20 are aligned mutually and are overlapped with each other, and then the sealing agent is cured by executing the annealing while applying the pressure to the substrates. A structure constructed by bonding the TFT substrate 10 and the opposing substrate 20 (a panel prior to the filling of the liquid crystal) is referred to as an empty panel hereunder.

Then, a vessel in which the liquid crystal is filled and the empty panel are loaded into the vacuum chamber (not shown), and then an interior of the vacuum chamber is exhausted into the vacuum state. Then, the liquid crystal filling port of the empty panel is put into the liquid crystal and then a pressure in the interior of the vacuum chamber is restored to the atmospheric pressure. Then, the liquid crystal enters into the empty panel because of difference between the pressure of the internal space of the empty panel and the atmospheric pressure, and then the liquid crystal is filled in the internal space of the panel. Then, the extra liquid crystal is pushed out by sandwiching the panel, in which the liquid crystal is filled, by two sheets of flat plates. Then, the liquid crystal filling port is sealed with the sealing resin.

As the liquid crystal 30, the liquid crystal whose dielectric anisotropy is negative and which exhibits a nematic phase at an ordinary temperature is employed. Then, the alignment control agent and the photopolymerization initiator are mixed into the liquid crystal. In this example, a mixture of monofunctional acrylate monomer and bifunctional acrylate monomer (mixing ratio 15:1) is employed as the alignment control agent. In this case, for example, an addition amount of the acrylate monomer is set to 2 wt % with respect to the liquid crystal and an addition amount of the photopolymerization initiator is set to about 2 wt % with respect to the acrylate monomer mixture.

Here, the alignment control agent is not limited to the above acrylate monomer mixture. However, when the alignment control agent is mixed into the liquid crystal and sealed between a pair of substrates, such alignment control agent is required to physically adhere to the picture element electrode and the common electrode and show the vertical alignment property to the molecules of the liquid crystal. Also, in the present embodiment, lauryl acrylate, etc. are contained in the acrylate monomer.

It is preferable that, in order to enhance the vertical alignment property, the dielectric anisotropy Δε of the liquid crystal should be set smaller. If the dielectric anisotropy Δε is about −3, the white line and the black dot cannot be observed practically with the naked eye. Also, if the dielectric anisotropy Δε is smaller than −5 (Δε<−5), it is possible to cause the white line and the black dot to disappear substantially.

However, according to the experiment made by the applicant of this application, it was confirmed that, out of the liquid crystals having the negative dielectric anisotropy, the liquid crystal that contains the fluorinated liquid crystal composition having the fluoro group exhibits the excellent vertical alignment property. Also, it was confirmed that, if the dielectric anisotropy is negative in the liquid crystal having the cyano group, the vertical alignment property is relatively poor, or the vertical alignment property is not shown in some case. In addition, it was confirmed that, out of the liquid crystals having the negative dielectric anisotropy, the liquid crystal that does not contain the liquid crystal composition having the unsaturated linkage is superior in the vertical alignment property. Further, it was confirmed that the liquid crystal having the tolane and the alkenyl group, which is effective to improve a response speed, is inferior in the vertical alignment property to the liquid crystal not having them even when they have the same dielectric anisotropy and, in the extreme case, such liquid crystal does not show the vertical alignment property.

The acrylate monomer in the liquid crystal that is filled between the TFT substrate 10 and the opposing substrate 20 is adhered onto the surfaces of the substrates 10, 20 and grown. If the ultraviolet ray is irradiated onto the acrylate monomer in this state, such acrylate monomer is polymerized and chemically bonded to the surfaces of the substrates 10, 20 and thus the stable alignment regulation layers 19, 25 are formed. The alignment regulation layers 19, 25 have a regulating power for aligning the molecules of the liquid crystal having the negative dielectric anisotropy vertically to the substrate surface. In this manner, the liquid crystal display panel of the present embodiment is completed.

Examined results of a relationship between the dielectric anisotropy of the liquid crystal and the vertical alignment property of the molecules of the liquid crystal will be explained hereunder.

Various liquid crystals having different dielectric anisotropy respectively are prepared. Then, the acrylate monomer and the photopolymerization initiator are mixed into these liquid crystals respectively.

The liquid crystal into which the acrylate monomer and the photopolymerization initiator are added by the same method as the above embodiment is filled between a pair of substrates (glass substrates) having transparent electrodes thereon, and then the alignment regulation layers are formed on the substrate surfaces on the liquid crystal layer side.

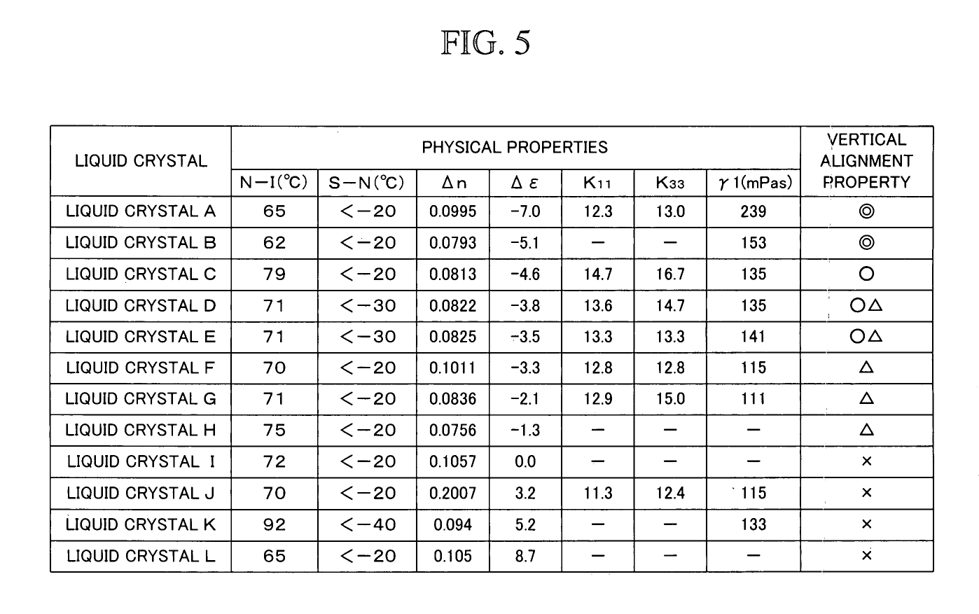

Physical properties of respective liquid crystals are shown in FIG. 5. Also, examined results of the vertical alignment property are also shown in FIG. 5. Where, in FIG. 5, N-I denotes a phase transition temperature between the nematic phase and the isotropic phase, and S-N denotes a phase transition temperature between the smectic phase and the nematic phase. Also, K₁₁ is a splay elastic constant, K₃₃ is a bend elastic constant, Δn is a refractive anisotropy, Δε is a dielectric anisotropy, and γ1 is a viscosity (rotation). Also, in FIG. 5, ⊚ denotes that the vertical alignment property is excellent, ◯ denotes that the vertical alignment property is good, Δ denotes that the vertical alignment property is fair, and denotes that the vertical alignment property is bad.

As can be appreciated from FIG. 5, in the liquid crystal whose dielectric anisotropy is neutral or positive, the vertical alignment property cannot be implemented and the molecules of the liquid crystal cannot be aligned perpendicularly to the substrate surface. In contrast, the white line and the black dot are considerably reduced if the dielectric anisotropy Δε is smaller than −3, while the white line and the black dot almost disappear if the dielectric anisotropy Δε is smaller than −5. In this case, even if the ultraviolet ray is not particularly irradiated, the vertical alignment type liquid crystal display panel can be manufactured.

In this case, in the above embodiment, the case that the present invention is applied to the transmissive liquid crystal display panel is explained. But the application field of the present invention is not limited to the transmissive liquid crystal display panel, and the present invention may be applied to the reflective liquid crystal display panel.

In the reflective liquid crystal display panel, if unevenness is formed to the surface of the reflection electrode to cause the diffused reflection, the good display characteristic can be obtained. Also, if the liquid crystal whose dielectric anisotropy Δε is about −7 is employed, the reflective liquid crystal display panel that shows the good vertical alignment property and shows the excellent optical characteristics can be manufactured. In this case, the step of forming the alignment film can be omitted.

(Second Embodiment)

A second embodiment of the present invention will be explained hereunder. Here, the present embodiment intends to prevent reduction in the display quality caused by the white line by being appropriate positions of the spacers.

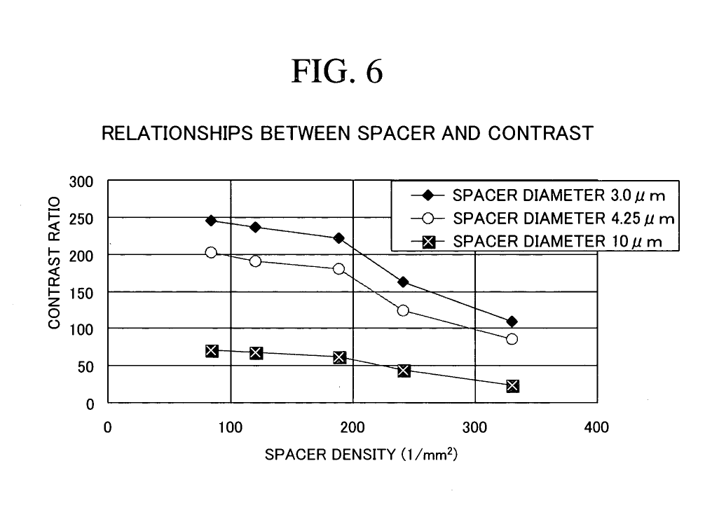

Relationships between a diameter and a scattering density of bead-like spacers and a contrast ratio at 0 V and 5 V are given in Table 1. Also, FIG. 6 is a graph showing relationships between the diameter and the scattering density of the bead-like spacers and the contrast ratio at 0 V and 5 V, wherein an abscissa denotes the spacer density and an ordinate denotes the contrast ratio.

TABLE 1

| | |
|---|---|
| Spacer | Contrast Ratio (0 V-5 V) |

| Scattering | Spacer | Spacer | Spacer |
|---|---|---|---|
| Density | Diameter | Diameter | Diameter |
| (1/mm²) | 3.0 μm | 4.25 μm | 10 μm |
| 84 | 245 | 203 | 71 |
| 120 | 236 | 190 | 68 |
| 188 | 221 | 180 | 62 |
| 241 | 162 | 124 | 44 |
| 330 | 110 | 86 | 24 |

From Table 1 and FIG. 6 , it is understood that the better contrast ratio can be obtained as the spacer density is reduced smaller. This is because a rate of presence of the spacers in the subpixel region is small.

Therefore, in the present embodiment, it is intended to reduce the spacer density and not place the spacer in the subpixel region by employing a column-like spacer formed of the photoresist in place of the bead-like spacer. If the spacer density is reduced, the number of generation of the black dot can be reduced and as a result generation of the white line can be suppressed. Also, since the white line is generated mainly in areas that are not relevant to the display between the subpixels, reduction in the display quality can be avoided.

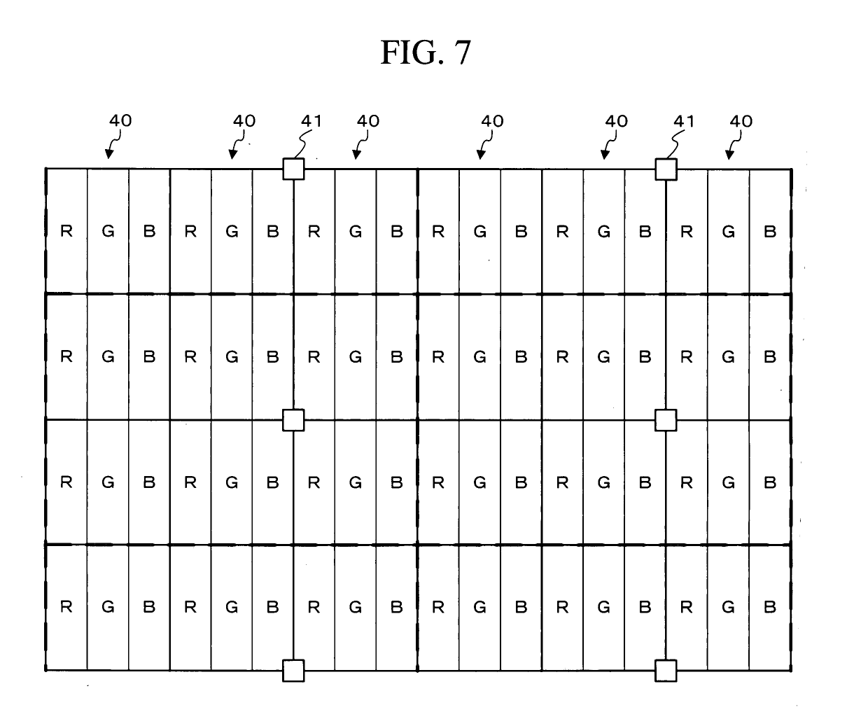

FIG. 7 is a schematic plan view showing positions of column-like spacers in a liquid crystal display panel according to the present embodiment. In this case, a different point of the present embodiment from the first embodiment resides in that an interval between a pair of substrates is maintained by column-like spacers 41. Other configurations are basically similar to those in the first embodiment.

In the present embodiment, the column-like spacers 41 are formed on any one of (both of) the TFT substrate and the opposing substrate by the photoresist. In this case, as shown in FIG. 7, one column-like spacer 41 is formed every six subpixels. Here, one pixel 40 consists of three subpixels of red (R), green (G) and blue (B). The case that the column-like spacers 41 are formed on the opposing substrate side will be explained herein.

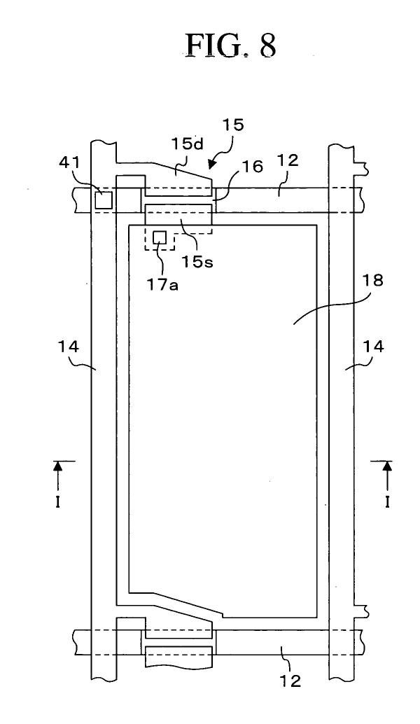

Like the first embodiment, the opposing substrate having the common electrode thereon is formed, then the photoresist film is formed on the overall upper surface of the opposing substrate, then the photoresist film is exposed via a predetermined exposure mask, and then the column-like spacers 41 are formed by developing the photoresist film. A height of the column-like spacers 41 is set to 4 μm, for example. Also, as described above, the column-like spacers 41 are formed in the areas between the subpixels at a rate of one spacer to six pixels. For example, as shown in FIG. 8 , the column-like spacers 41 may be formed at intersection portions between the gate bus lines 12 and the data bus lines 14 . Also, a layer providing the horizontal alignment property or the vertical alignment property may be formed on surfaces of the column-like spacers 41 .

Then, the TFT substrate and the opposing substrate are arranged to oppose to each other and put the column-like spacers 41 therebetween, then the TFT substrate and the opposing substrate are bonded by the sealing agent, and then the liquid crystal whose dielectric anisotropy is negative is filled between them. Like the first embodiment, the alignment control agent and the photopolymerization initiator are mixed previously into the liquid crystal.

Then, the alignment regulate layer is formed on the picture element electrodes of the TFT substrate and the common electrode of the opposing substrate by irradiating the ultraviolet ray. In this manner, the liquid crystal display panel of the present embodiment is completed.

In the present embodiment, the interval (cell gap) between the TFT substrate and the opposing substrate is maintained constant by the column-like spacers that are formed of the photoresist film at the predetermined positions. In this case, even though the alignment control agent is separated round the spacers as the nucleus to generate the black dot, such black dot is generated in the areas that have no relation to the display between the subpixels and thus has the small influence upon the display characteristics. Also, since the white line is generated to connect the black dots, such white line is seldom generated in the subpixel areas. As a result, the step of forming the alignment film can be neglected and thus the liquid crystal display device that can provide the excellent display quality can be obtained.

What is claimed is:

1. A liquid crystal display panel in which a liquid crystal into which an alignment control agent is added is filled between a pair of substrates and an alignment regulate layer is formed on liquid crystal side surfaces of the pair of substrates respectively,
wherein the liquid crystal shows a nematic phase at an ordinary temperature and a dielectric anisotropy of the liquid crystal is negative.

2. A liquid crystal display panel according to claim 1, wherein the dielectric anisotropy Δε of the liquid crystal is Δε<−3.

3. A liquid crystal display panel according to claim 1, wherein acrylate monomer is used as the alignment control agent.

4. A method of manufacturing a liquid crystal display panel, comprising the steps of:
preparing the liquid crystal that shows a nematic phase at an ordinary temperature and has a negative dielectric anisotropy;
adding an alignment control agent into the liquid crystal;
filling the liquid crystal, into which the alignment control agent is added, between a pair of substrates at least one of which is transparent; and
forming an alignment regulate layer by causing the alignment control agent to adhere onto liquid crystal side surfaces of the pair of substrates respectively.

5. A method of manufacturing a liquid crystal display panel, according to claim 4, wherein acrylate monomer is used as the alignment control agent.

6. A method of manufacturing a liquid crystal display panel, according to claim 4, wherein the alignment regulate layer is formed by causing the alignment control agent being adhered onto the substrates to optically react.

7. A liquid crystal display panel in which a liquid crystal into which an alignment control agent is added is filled between a pair of substrates and an alignment regulate layer is formed on liquid crystal side surfaces of the pair of substrates respectively,
wherein column-like spacers for maintaining an interval between the pair of substrates constant are arranged in areas between subpixels.

8. A liquid crystal display panel according to claim 7, wherein the column-like spacers are formed by exposing and developing a photoresist.

9. A liquid crystal display panel according to claim 7, wherein the liquid crystal shows a nematic phase at an ordinary temperature and a dielectric anisotropy of the liquid crystal is negative.

10. A liquid crystal display panel according to claim 7, wherein the column-like spacers are formed at a rate of one spacer to plural pixels.

11. A method of manufacturing a liquid crystal display panel, comprising the steps of:
forming column-like spacers in areas between subpixels on at least one of a pair of substrates by exposing and developing a photoresist;
preparing the liquid crystal into which an alignment control agent is added;
arranging the pair of substrates to put the column-like spacers therebetween, and filling the liquid crystal into which the alignment control agent is added between the pair of substrates; and
forming an alignment regulate layer by causing the alignment control agent to adhere onto liquid crystal side surfaces of the pair of substrates respectively.

12. A method of manufacturing a liquid crystal display panel, according to claim 11, wherein acrylate monomer is used as the alignment control agent.
